(19) United States
(12) Patent Application Publication
(10) Pub. No.: US 2009/0106843 A1
(43) Pub. Date: Apr. 23, 2009

(54) SECURITY RISK EVALUATION METHOD FOR EFFECTIVE THREAT MANAGEMENT

(76) Inventors: Pil-Yong Kang, Yongin-si (KR); Won-Tae Sim, Seongnam-si (KR); Woo-Han Kim, Seoul (KR)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 11/941,193

(22) Filed: Nov. 16, 2007

(30) Foreign Application Priority Data
Oct. 18, 2007 (KR) 10-2007-0105228

(51) Int. Cl. H04L 9/00

(52) U.S. Cl. 726/25

(57) ABSTRACT

Provided is a security risk evaluation method for threat management. According to the present invention, new threats or vulnerabilities for a network which should be protected (target network) are collected, and a threat management environment is assessed by checking whether or not to apply attack-attempt detection rules and vulnerability assessment rules for assets related to the threats or vulnerabilities. Based on the assessment result, the range and level of response are previously checked and complemented, and corresponding risk evaluation is provided. Therefore, the threat management environment can be managed effectively.

### BACKGROUND OF THE INVENTION

1. Field of the invention

The present invention relates to a security risk evaluation method for threat management. According to the present invention, new threats or vulnerabilities for a network which should be protected (hereinafter, referred to as ‘target network’) are collected, and a threat management environment is assessed by checking whether or not to apply attack-attempt detection rules and vulnerability assessment rules for assets related to the threats or vulnerabilities. Based on the assessment result, the range and level of response are previously checked and complemented, and corresponding risk evaluation is provided. Therefore, the threat management environment can be managed effectively.

2. Description of the Prior Art

Network security threats such as worms, viruses, hacking, and so on and infringements related thereto are becoming more and more sophisticated and complicated, and the period of occurrence thereof is becoming shorter. As a measure against the threats, a threat management system attracts attentions. The threat management system is a unified security management system which collects and analyzes threats and security information for IT assets so as to support warning and management. Such a threat management system collects and analyzes information on new threats from a reliable external information security agency and then provides the information to a security manager, in addition to threat analysis such as intrusion detection, traffic analysis, and correlation analysis in a local region. Therefore, the security manager can previously assess vulnerabilities and thus construct a response system to an infringement.

Cisco TR (Threat Response), which supports a response to a security threat, investigates an intrusion alert generated by the detection of an attack-attempt. When the system receives an alert, it analyses related asset information and vulnerabilities to determine if the attack was real or false. Thus, the Cisco TR can support an effective and rapid response to a real attack. However, it is difficult to previously grasp how sufficiently detection rules and a vulnerability assessment environment are prepared against known threats. Further, when an assessment result on vulnerabilities related to the intrusion alert is omitted, the expected effect is significantly decreased.

Symantec DeepSight TMS (Threat Management System) is a system which checks global network status and vulnerability information, and supports threat management based on security logs collected in a target network. However, the system does not support a systematic analysis on whether the currently operated security system, including attack-attempt detection rules and vulnerability assessment rules, is proper or not.

As such, when the conventional threat management systems are used, it is difficult to grasp how sufficiently a currently-operated security system can detect attacks which may affect important assets and how sufficiently a currently-operated vulnerability scanner can cover the corresponding threats. Therefore, there are difficulties in judging whether the current security management system, including attack-attempt detection rules and vulnerability assessment rules, is applied and operated properly.

### SUMMARY OF THE INVENTION

An advantage of the present invention is that it provides a security risk evaluation method for threat management, in which new threats or vulnerabilities for a target network are collected, and a threat management environment is assessed by checking whether or not to apply attack-attempt detection rules and vulnerability assessment rules related to the threats or vulnerabilities. Based on the assessment result, the threat management environment is complemented, and a security risk is evaluated correspondingly.

According to an aspect of the present invention, a security risk evaluation method for a threat management environment of a target network includes the steps of: (a) collecting new threats or vulnerabilities for the network and storing them into a database; (b) assessing whether assets related to the new threats or vulnerabilities are present in the network or not; (c) assessing whether or not to apply attack-attempt detection rules related to the assets; (d) assessing whether or not to apply vulnerability assessment rules related to the assets; (e) adding omitted vulnerabilities, attack-attempt detection rules, and vulnerability assessment rules based on the assessment results of steps (c) and (d); and (f) calculating security risks based on the assessment results.

### BRIEF DESCRIPTION OF THE DRAWINGS

The above and other objects, features and advantages of the present invention will be more apparent from the following detailed description taken in conjunction with the accompanying drawings, in which:

FIG. 1 is a flow chart illustrating a conventional threat management procedure;

FIG. 2 is a diagram illustrating an open framework for threat management for applying a security risk evaluation method according to the present invention;

FIG. 3 is a flow chart illustrating a security risk evaluation method according to the present invention; and

FIG. 4 is a table illustrating an assessment result of security risk according to an embodiment of the present invention.

### DETAILED DESCRIPTION OF EMBODIMENTS

Hereinafter, an embodiment of the present invention will be described with reference to the accompanying drawings. However, the present invention is not limited to the embodiment.

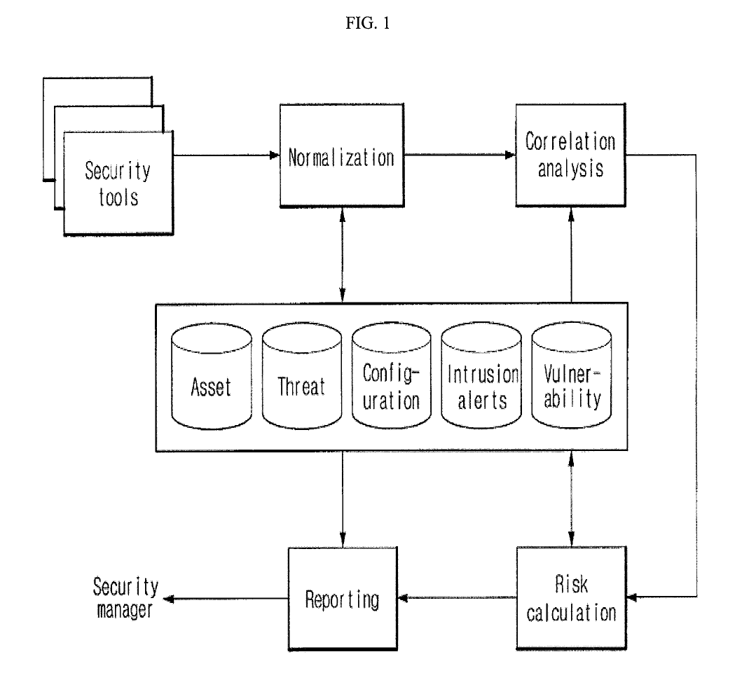

FIG. 1 is a flow chart illustrating a conventional threat management procedure. As shown in FIG. 1, the threat management procedure generally includes the steps of: collecting security logs from security tools; normalizing the collected security logs, analyzing correlations between the security logs and threats and assets; calculating a security risk; and when the security risk is high, reporting the security risk to a security manager.

In general, a single security system which is optimal for all network environments does not exist. Therefore, it is preferable that a variety of security systems are properly combined so as to construct a unified security system. To construct such a unified security system, an open framework for threat management is utilized. A security risk evaluation method according to the present invention is also based on an open framework for threat management which will be described below.

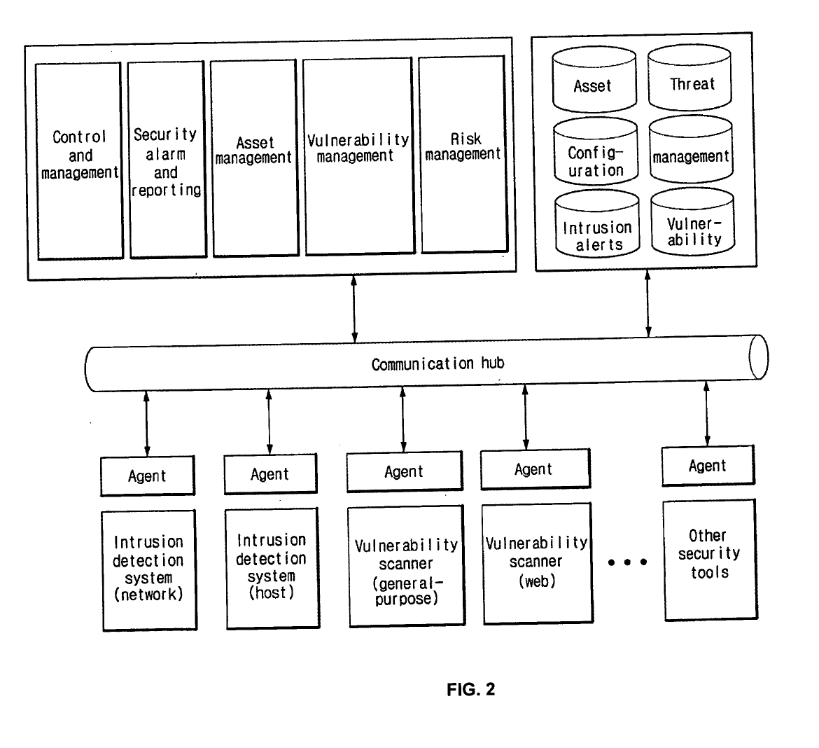

FIG. 2 is a diagram illustrating an open framework for threat management for applying a security risk evaluation method according to the present invention. In a threat management environment according to an embodiment of the present invention, security tools such as intrusion detection systems (IDS), vulnerability scanners, and so on are installed, and the respective modules over the framework are interconnected by transmission of messages between agents through a communication hub.

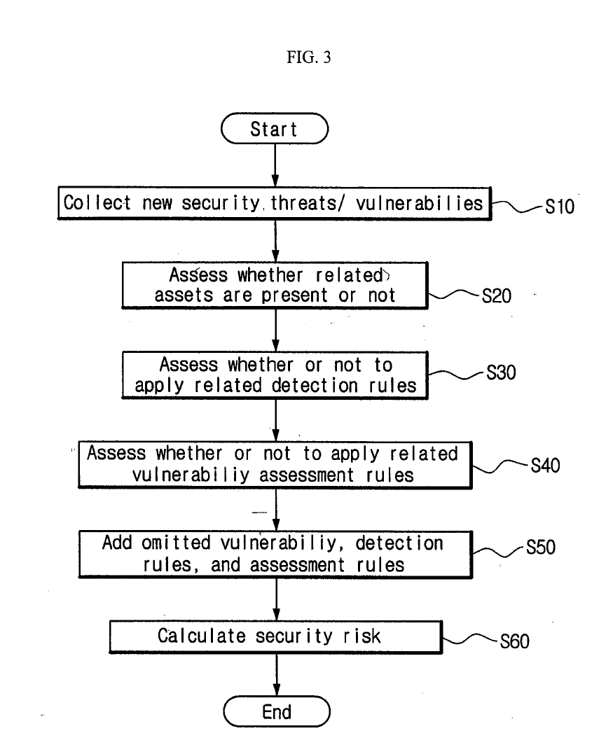

FIG. 3 is a flow chart illustrating a security risk evaluation method according to the present invention. First, when new security threats or vulnerabilities are found, they are collected (step S10), and are then stored in a threat and/or vulnerability database. Then, it is assessed whether or not assets related to the new threats and/or vulnerabilities are present in a target network (step S20). The assessment is performed by mapping the threats and/or vulnerabilities with assets which are previously stored in an asset database. Then, it is assessed whether or not to apply attack-attempt detection rules related to the assets (step S30). That is, it is checked whether the IDS installed in the threat management environment detects a new threat or not, and the frequency of the detection is examined. Further, it is assessed whether or not to apply vulnerability assessment rules related to the assets (step S40). The assessment is performed as follows: it is checked whether or not the vulnerability scanner installed in the threat management environment supports vulnerability scanning on a new vulnerability, and it is examined whether or not a new vulnerability is found in the assets. Then, based on the security assessment result, omitted vulnerabilities, attack-attempt detection rules, and vulnerability assessment rules are added so as to complement a security response system (step S50). Then, a security risk is calculated (step S60).

According to the present invention, a quantitative calculation of risk on each asset and threat is possible. For the quantitative risk assessment, the overall risk level is calculated based on an attack-attempt detected for each asset, a vulnerability assessment result, an asset value A, and an impact degree I which represents a vulnerability level for a known vulnerability.

The risk for each asset and risk can be expressed by the product of an attack frequency T, an impact degree I, and an asset value A.

A risk Rₐ(i) for an asset i can be calculated by Equation 1. In Equation 1, T(i) represents an attack frequency verified for the asset i. The attack frequency is a value verified on the basis of information on assets and vulnerabilities with respect to intrusion warnings collected for a predetermined duration of time defined by a security manager. V(i) represents a vulnerability index list of the asset i, and I(t) represents an impact degree for a threat (or vulnerability) t. Therefore, ΣI(V(i)) represents the sum of impact degrees for all vulnerabilities of the asset i. Further, A(i) represents a value for the asset i, which is allocated by the security manager.

Rₐ(i)=T(i)×ΣI(V(i))×A(i) [Equation 1]

A risk Rₜ(t) for a threat t can be calculated by Equation 2. In Equation 2, T(i, t) represents an attack frequency verified for the asset i with the threat t, and A(i, t) represents a value for the asset i with the threat t.

$${R}_{t} ( t ) = {\sum }_{i = 0}^{n - 1} T ( i , t ) \times I ( t ) \times {\sum }_{j = 0}^{n - 1} A ( j , t ) \qquad [ Equation 2 ]$$

A response degree Pₜ(t) for an attack using the threat t can be calculated by Equation 3. In Equation 3, Pₜ(j, t) represents a value 0 or 1 indicating whether a security tool j responds to the threat t or not. Here, the security tool may be an IDS, a vulnerability scanner, and so on, and k represents the number of available security tools.

$${P}_{t} ( t ) = \frac{{\sum }_{j = 0}^{k - 1} {P}_{t} ( j , t )}{k} . \qquad [ Equation 3 ]$$

A response degree Pₐ(i) for the threat and attack on the asset i can be calculated by Equation 4. In Equation 4, COUNT(V(i)) represents the number of actual vulnerabilities of the asset i, and ΣPₜ(V(i)) represents the sum of response degrees for the respective vulnerabilities of the asset i.

$${P}_{a} ( i ) = \frac{\sum {P}_{t} ( V ( i ) )}{COUNT ( V ( i ) )} \qquad [ Equation 4 ]$$

All of the attack frequency, the impact degree and the asset value can be evaluated both qualitatively and quantitatively. When a weight allocated by a manager is provided, the equations can be corrected so as to be suitable for a specific operation environment.

In the above-described embodiment, the procedures of the security risk evaluation method have been described, in which the IDS and the security scanner are installed in the threat management environment. Therefore, when other type of security tool is additionally installed, the method may further include an assessment step using the additional security tool after step S40.

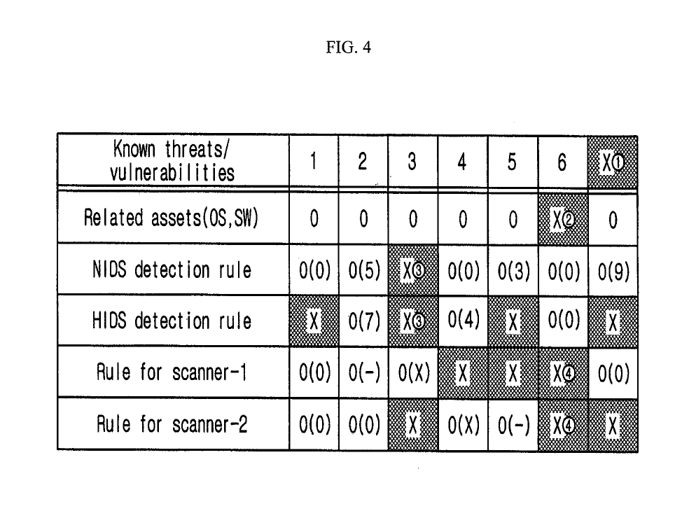

According to the security risk evaluation method, the assessment result of security risk can be presented in assessment table shown in FIG. 4. Therefore, it is possible to easily check whether security measures are prepared or not. In the assessment table shown in FIG. 4, X marked on the hatched area represents the omission of related item, and the number in parenthesis ( ) represents the number of the detections of attack-attempts or the results of vulnerability assessment. O means that an attack-attempt or vulnerability is found, X means that no attack-attempt or vulnerability is found, and - means that an assessment is not performed. Further, NIDS represents a network-based intrusion detection system, and HIDS represents a host-based intrusion detection system.

Based on the assessment table, the response operation that can be carried out by a security manager can be roughly divided into the following four kinds of operations. In FIG. 4, a case represented by \textcircled{1} indicates a state where a related threat is not present, that is, where a related threat is not present in a threat database, but an asset related to detection and assessment rules is present. In this case, the security manager can add a new threat into the threat database. Further, a case represented by \textcircled{2} indicates a state where a related asset is not present in a target network. In this case, related detection and assessment rules do not need to be applied. Meanwhile, a case represented by \textcircled{3} indicates a case where a related attack-attempt detection rule is not provided in the threat management environment. In this case, the security manager can generate the corresponding detection rule by itself or additionally install an IDS which supports it. Further, a case represented by \textcircled{4} indicates a case where a related vulnerability assessment rule is not provided in the threat management environment. In this case, the security manager can generate the corresponding detection rule by itself or additionally install a vulnerability scanner which supports it.

As described above, when the security risk evaluation method and the assessment result through the assessment table are used, threats and vulnerabilities related to important assets which belong to a target network are previously examined, and the threat management environment is assessed. Therefore, it is possible to check the insufficiency of security measures against known threats and to enhance a security level in response to that.

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

According to the present invention, threats and vulnerabilities related to important assets which belong to a target network are previously examined, and the threat management environment including related attack-attempt detection rules and vulnerability assessment rules is assessed. Therefore, the range and level of response for a known threat can be previously checked and complemented, and the threat management environment can be managed effectively through risk evaluation, for example, by allocating priorities.

What is claimed is:

1. A security risk evaluation method for a threat management environment of a target network, the security risk evaluation method comprising the steps of:
(a) collecting new threats or vulnerabilities for the network and storing them into a database;
(b) assessing whether assets related to the new threats or vulnerabilities are present in the network or not;
(c) assessing whether or not to apply attack-attempt detection rules related to the assets;
(d) assessing whether or not to apply vulnerability assessment rules related to the assets;
(e) adding omitted vulnerabilities, attack-attempt detection rules and vulnerability assessment rules based on the assessment results of steps (c) and (d); and
(f) calculating security risks based on the assessment results.

2. The security risk evaluation method according to claim 1, wherein in step (c), it is examined whether or not an intrusion detection system (IDS) installed in the threat management environment detects the new threats and how many times the IDS detects the threats.

3. The security risk evaluation method according to claim 1, wherein in step (d), it is examined whether or not a vulnerability scanner installed in the threat management environment supports vulnerability scan for the new threats and whether or not the vulnerability scanner has found the new threats.

4. The security risk evaluation method according to claim 1, wherein the assessment results of steps (b) to (d) are presented in an assessment table.

5. The security risk evaluation method according to claim 1, wherein in step (f), the security risks are calculated for the respective assets included in the network and the respective threats related to the assets.

6. The security risk evaluation method according to claim 5, wherein the security risk for each asset and threat is calculated as the product of an attack frequency, an impact degree and an asset value.
